(19) United States
(12) Patent Application Publication
(10) Pub. No.: US 2022/0179054 A1
(43) Pub. Date: Jun. 9, 2022

(54) APPARATUS FOR RECOGNIZING OBJECTS, AND VEHICLES

(71) Applicant: Hybrid Lidar Systems AG, Bad Salzdetfurth (DE)

(72) Inventor: Eltaher Amr, Braunschweig (DE)

(21) Appl. No.: 17/436,274

(22) PCT Filed: Sep. 5, 2020
(86) PCT No.: PCT/EP2020/055940

§ 371 Date: Sep. 3, 2021

(30) Foreign Application Priority Data
Mar. 5, 2019 (EP) 19160757.1

(51) Int. Cl. G01S 7/481; G01S 17/42; G01S 17/931; G01S 7/4863; G01S 7/486; G01S 7/487

(52) U.S. Cl. CPC G01S 7/4815; G01S 17/42; G01S 17/931; G01S 7/4817; G01S 7/4868; G01S 7/487; G01S 7/4863

(57) ABSTRACT

The present invention relates to an apparatus (10) for recognizing objects (12) in a monitoring environment (50), said apparatus (10) having a transmission section (20) for transmitting light (60), in particular laser light, into the monitoring environment (50) and a receiving section (30) for receiving light (66) reflected at objects (12) in the monitoring environment (50). Furthermore, the present invention relates to a vehicle (100) comprising an apparatus (10) for recognizing objects (12) in a monitoring environment (50).

The present invention relates to an apparatus for recognizing objects in a monitoring environment, said apparatus having a transmission section for transmitting light, in particular laser light, into the monitoring environment and a receiving section for receiving light reflected at objects in the monitoring environment. The present invention further relates to a vehicle comprising an apparatus for recognizing objects in a monitoring environment.

Light-based apparatus for recognizing objects in monitoring environments are generally known. One area of use of such apparatus is, for example, in vehicles, wherein a measurement of distances from objects in the environment of the vehicle can here, for example, be provided to the vehicle by these apparatus. Such apparatus for recognizing objects can thus in particular contribute to a data basis for an autonomously performed driving of a vehicle.

Known apparatus for recognizing objects in this respect have a light source, usually a single light source, through which light is transmitted into the environment. Light reflected at objects returns to the apparatus, is registered in or by them, and is used to determine or recognize objects in the corresponding monitoring environment.

It is an object of the present invention to generally improve apparatus for recognizing objects in a monitoring environment as well as vehicles. It is in particular an object of the present invention to provide an apparatus for recognizing objects in a monitoring environment and a vehicle that are improved such that a speed of the recognition of the objects is increased, and/or a resolution is improved at least in certain sections of the monitoring environment, and/or an energy that is required to recognize objects in the monitoring environment can be lowered.

The above object is satisfied by an apparatus for recognizing objects in a monitoring environment having the features of claim 1 and by a vehicle having the features of claim 18. All the features and advantages that are described with respect to an apparatus in accordance with the invention can also be provided by a vehicle in accordance with the invention and vice versa such that reference is or can in each case be alternately made to the individual invention aspects. Further optional features and advantages of the invention result from the dependent claims, from the description, and from the drawings.

In accordance with a first aspect of the invention, the object is satisfied by an apparatus for recognizing objects in a monitoring environment, said apparatus having a transmission section for transmitting light, in particular laser light, into the monitoring environment and a receiving section for receiving light reflected at objects in the monitoring environment.

In an apparatus in accordance with the invention, provision is made that the transmission section has a first transmission unit for transmitting light having a first light property into a first illumination section of the monitoring environment and at least a second transmission unit for simultaneously transmitting light having a second light property into a second illumination section of the monitoring environment, wherein the first light property and the at least a second light property are formed differently, and wherein the receiving section has a receiving unit for simultaneously receiving reflected light having the first light property and reflected light having the at least a second light property.

An apparatus in accordance with the invention can be characterized in that the first light property of the light transmitted by the first transmission unit and the at least a second light property of the light transmitted by the at least a second transmission unit are formed as a color mixture, with a first light color being used only as a portion of the first light property, a second light color being used only as a portion of the second light property, and at least a third light color being used as a portion of both light properties, with further the first transmission unit and the at least a second transmission unit being configured for a flash-like illumination of the respective illumination section for a complete illumination of the respective illumination section.

An apparatus in accordance with the invention is configured to recognize objects in a monitoring environment, wherein light is in particular used for this purpose by an apparatus in accordance with the invention. This light can preferably be formed as laser light, with in particular the advantageous properties of laser light, for example with respect to focusability, wavelength stability and/or phase stability, being able to be used here. Light in the sense of the invention is in particular understood as visible light, i.e. electromagnetic radiation having a wavelength between approximately 400 nm and approximately 800 nm, but also as adjoining ranges of the electromagnetic spectrum such as UV light and/or infrared light.

To recognize objects in the monitoring environment, the light is transmitted by a transmission section of the apparatus in accordance with the invention, is reflected at an object in the monitoring environment, and is subsequently received again by a receiving section of the apparatus in accordance with the invention. In further possible elements of the apparatus in accordance with the invention, for example of an evaluation unit, the determined data of the receiving section can be analyzed and the object in the monitoring environment can be recognized in this way. Alternatively or additionally, this analysis of the data can also be performed outside the apparatus in accordance with the invention in additional external evaluation units.

The transmission section has a first transmission unit and at least a second transmission unit. The at least two transmission units can, for example, be at least substantially of the same construction, wherein they, however, differ in the specific light that they can each transmit. For this purpose, they can in particular also be formed as a separate assembly in each case. Alternatively, an integration of the at least two transmission units into a single assembly, for example in a common housing, is also conceivable. Thus, the first transmission unit can transmit light having a first light property and the second transmission unit can transmit light having a second light property. The two light properties are different in this respect. In this way, it can in particular be made possible on a receiving of reflected light, based on its light property, to perform an association of the received light with the respective corresponding transmission unit.

The two transmission units are further designed and/or arranged such that the first transmission unit transmits its light into a first illumination section of the monitoring environment and the second transmission unit transmits its light into a second illumination section of the monitoring environment. In other words, in an apparatus in accordance with the invention, the monitoring environment is illuminated with light that has different light properties depending on the transmission section from which it originates. Since the transmission of the light by the transmission units of the transmission section occurs simultaneously, the total monitoring environment is thus completely covered on each illumination with light by the transmission section. In this respect, each individual subregion of the monitoring environment, covered by at least one illumination section, is illuminated by light from at least one of the transmission units.

Depending on where an object is located in the monitoring environment, it reflects light from the first transmission unit having the first light property and/or light from the at least a second transmission unit having the second light property. To receive this reflected light, an apparatus in accordance with the invention has a receiving section having a receiving unit, wherein the receiving unit is configured both to recognize reflected light having the first light property and to recognize reflected light having the at least a second light property. This recognition of light having the at least two light properties in particular takes place simultaneously by the receiving unit of the receiving section. In other words, it is irrelevant for a recognition of the object in the monitoring environment whether said object is illuminated by light of the first transmission unit, by light of the second transmission unit, or by light from both transmission units. In other words, the total monitoring environment, which corresponds to the total spatial angle range illuminated by the at least two transmission units, can be simultaneously monitored by the receiving unit. A simultaneous detection of objects can thereby be made possible for the total monitoring environment.

An apparatus in accordance with the invention can also be characterized in that the first light property and the at least a second light property are formed as a color mixture of the corresponding light, with a first light color, in particular blue, being used only as a portion of the first light property, a second light color, in particular green, being used only as a portion of the second light property, and at least a third light color, in particular red, being used as a portion of both light properties. In this respect, it can preferably be taken into account that light can have different properties depending on its light color. A propagation of the light can, for example, be dependent on environmental conditions; a longer wavelength light is in particular, for example on the occurrence of snow or rain, less strongly attenuated by scattering than a light of a shorter wavelength in comparison thereto. Light colors in the sense of the invention can in this respect preferably be provided as narrowly limited wavelength bands, for example, ±25 nm, preferably ±5 nm, around a mean value, for example, blue around the mean value of approximately 470 nm and/or green around the mean value of approximately 540 nm. On the use of laser light, these wavelength bands can be limited even further up to monochromatic light. Since a first light color can be used only as a portion of the first light property and a second light color can be used only as a portion of the second light property, a simultaneous recognition of the two different types of light in the receiving unit of the receiving section can be provided particularly easily. At the same time, a distinction of the two types of light can be made particularly easily. Furthermore, at least a third light color, for example red (mean value of the wavelength band preferably at approximately 700 nm) is additionally also used as a portion of both light properties. For example, a brightness of an illumination of the total monitoring environment can thereby be improved overall and a recognition of, for example, only weakly reflective objects in the monitoring environment can thereby be facilitated.

The apparatus in accordance with the invention can also be configured such that the first transmission unit and the at least a second transmission unit are configured for a flash-like illumination of the respective illumination section. A flash-like illumination completely illuminates the total illumination section. A flash-like illumination can provide a particularly fast recognition of objects in the monitoring environment. On a complete, flash-like illumination of the respective illumination section, a use of moving parts, for example of a movable mirror, for the angle-dependent deflection of a light of the corresponding transmission unit can preferably be dispensed with.

Provision can also be made in an apparatus in accordance with the invention that at least a fourth light color is used as a portion of the first light property and/or of the at least a second light property. In other words, the color mixtures of the first and/or the second light property are not limited to two light colors in each case, but can also be formed as color mixtures of three or more light colors. In this respect, a fourth light color, which is only used in one of the color mixtures, can enable an even better differentiation of light having the different light properties, for example. A fourth light color that is present in the color mixtures of both the first light property and the at least a second light property can in turn, for example, provide an even better or brighter illumination of the total monitoring environment.

An apparatus in accordance with the invention can further be designed such that the first transmission unit comprises a first dichroic mirror for combining at least light having the first light color and light having the third light color into light having the first light property, and/or that the at least a second transmission unit comprises a second dichroic mirror for combining at least light having the second light color and light having the third light color into light having the second light property. A dichroic mirror is an optical component that selectively reflects only a portion of the light spectrum, in particular light of one wavelength range or light of one light color, wherein light outside this wavelength range or light having a different light color can pass through the dichroic mirror.

The first transmission unit can as a whole be configured to transmit light having the first light property, wherein the first light property is formed as a color mixture of the first and third light colors. The first transmission unit usually has two light emitters, one for the first light color and one for the second light color. These two light emitters are arranged with respect to the first dichroic mirror such that light of that light emitter for whose light color the dichroic mirror is permeable passes through the mirror at least substantially unimpeded, and light of the correspondingly other light transmitter for whose light color the dichroic mirror acts in a reflective manner is reflected at said dichroic mirror such that, after the dichroic mirror, it is aligned in parallel with the light of the first light transmitter. In other words, the two separately provided light portions having the different light colors are combined by the dichroic mirror into the light having the first light property, that is the color mixture of the first light color and the third light color. In this respect, the dichroic mirror can, for example, be provided as permeable for the first light color and reflective for the third light color. Alternatively, a design of the dichroic mirror opposite thereto is also conceivable.

Analogously, the provision of light having the second light property, that is a color mixture of the second light color and the third light color, can also be simplified using a dichroic mirror. In this case, the dichroic mirror is then provided permeable for the second light color and reflective for the third light color or can alternatively be provided reflective for the second light color and permeable for the third light color.

Provision can further be made that the light having the third light color is provided for both the first transmission unit and the second transmission unit from a light transmitter used in common.

On the use of a fourth light color as part of the color mixture of the first light property and/or second light property, the first transmission unit and/or the second transmission unit can accordingly also have further suitable dichroic mirrors to add light having the fourth light color to the light having the respective color mixture.

An apparatus in accordance with the invention can also be designed such that the receiving section, in particular the receiving unit, has at least a third dichroic mirror for splitting the light colors of the first light property and the second light property of the reflected light. The light reflected in the monitoring environment, in particular at objects in the monitoring environment, can have both the first light property and the second light property, depending on whether the reflected light was transmitted by the first transmission unit or the second transmission unit. The first, second, and third light colors, optionally also at least a fourth light color, are thus present in the reflected light. A division of the reflected light into light each preferably having only one light color can now be provided by at least a third dichroic mirror as an element of the receiving section, in particular as an element of the receiving unit. A use of light detectors that are coordinated with the respective light color and are thus particularly sensitive can be made possible in this way. Overall, a sensitivity of the receiving unit can thus be increased.

An apparatus in accordance with the invention can preferably be configured such that the first illumination section and the at least a second illumination section completely or at least substantially completely cover the monitoring environment. In other words, provision can preferably be made that a contamination quantity of the first illumination section and of the at least a second illumination section comprises the monitoring environment or is even formed larger than the latter. A recognition of objects in the total monitoring environment can be ensured in this way.

A further developed embodiment can include the fact that the first illumination section and the at least a second illumination section cover the monitoring environment in equal parts or at least substantially equal parts, with preferably the monitoring environment covering an angular range of 120°×40° and the first illumination section and the second illumination section each covering 60°×40° of said angular range. In other words, provision can preferably be made that the monitoring environment is not only completely covered by the individual illumination sections of the transmission units, but is divided among them in equal parts. Thus, each of the transmission units transmits its light into an illumination section, wherein the individual illumination sections of all the transmission units are of equal size. A synchronization of these illuminations or illuminations of the individual illumination sections can thus be simplified. In a preferred monitoring environment in an angular range of 120°×40°, in each case measured with respect to a central measurement direction of the apparatus in accordance with the invention, a division of the two illumination sections into 60°×40° in each case can thus preferably be provided when two transmission units are present.

An apparatus in accordance with the invention can also be configured such that the first illumination section and the at least a second illumination section do not overlap, and/or that the first illumination section and the at least a second illumination section are adjacent to one another, preferably at least partly directly adjacent to one another. A particularly energy-saving complete illumination of the total monitoring environment can be provided by an avoidance of an overlap. An adjoining, in particular a direct adjoining, of the two illumination sections can in turn ensure that no region of the monitoring environment that is not illuminated with light by one of the two transmission units remains between the two illumination sections.

Alternatively, provision can be made that the first illumination section and the at least a second illumination section overlap in a redundancy region, in particular that the at least a second illumination section completely overlaps with the first illumination section and thus forms the redundancy region. In other words, in this redundancy section, a present object is illuminated by at least two transmission units having both light having the first light property and light having the at least a second light property and is subsequently recognized by a registration of the reflected light having both the first light property and the at least a second light property by the receiving unit of the receiving section. A recognition of this object can thus be provided with a higher degree of certainty, on the one hand, wherein a resolution of the recognized object can, for example, also be simultaneously increased. In particular on a complete overlap of the at least a second illumination section with the first illumination section, it can also be made possible to generate an overview of the total monitoring environment and objects present therein through the first illumination section and to simultaneously provide a preferably more detailed view of sections of the monitoring environment, in particular sections adapted to present objects, through the at least a second illumination section.

The two above-mentioned embodiments, mutually adjoining illumination sections and alternatively overlapping illumination sections, each mostly apply to a fixed spacing of the considered monitoring environment from the receiving section of the apparatus in accordance with the invention. Both variants, non-overlapping illumination sections and overlapping illumination sections, can in particular be implemented simultaneously in the same apparatus for two or more considered monitoring environments at different spacings. For example, one or more monitoring environments can in particular also only in an evaluation performed by or downstream of the apparatus in accordance with the invention be defined and/or evaluated at different spacings from the receiving section.

Thus, in accordance with a further embodiment of an apparatus in accordance with the invention, provision can be made that the first illumination section is arranged at a first spacing from the receiving section and the at least a second illumination section is arranged at a second spacing from the receiving section, with the first spacing and the second spacing being formed differently. In other words, the first illumination section can, for example, be a close region arranged closer to the receiving section and the second illumination section can be a further remote far region. In this way, it can, for example, be provided by an apparatus in accordance with the invention to simultaneously monitor both the far region and the near region. In this embodiment, the total monitoring environment results from the now spatially separate individual illumination sections. As already indicated above, the near range can, for example, also be at least partly illuminated by the light provided for illuminating a far range and vice versa, wherein this can be taken into account in an evaluation performed by or downstream of the apparatus in accordance with the invention in order, for example, to improve a resolution of the near region and/or an illumination of the far region even further.

An apparatus in accordance with the invention can also be configured such that the first transmission unit and/or the at least a second transmission unit and/or the receiving unit, in particular the total transmission section and/or the total receiving section, are formed free of moving parts, in particular movable mirrors. The transmission units of the apparatus in accordance with the invention are configured for a flash-like complete illumination or illumination of the total respective illumination section. The receiving unit is in turn likewise configured to fully and simultaneously receive reflected light from the total monitoring environment. Moving parts, such as movable mirrors, which are usually necessary for scanning an illumination section in the transmission section and/or receiving section, can thus be dispensed with in an apparatus in accordance with the invention. Due to such a design of an apparatus in accordance with the invention free of moving parts, said apparatus can overall be provided in a mechanically simpler manner and can therefore also be provided easier to maintain and less prone to mechanical failure.

An embodiment of an apparatus in accordance with the invention can further comprise that the receiving unit has a plurality of light sensors, with in particular the light sensors being arranged in a sensor matrix, preferably as pixels of the sensor matrix, with the sensor matrix particularly preferably having 600×200 light sensors as pixels. Due to the provision of a plurality of light sensors, a sensitivity of the receiving unit of the receiving section can in particular be increased, for example. A recognition of objects at which the light transmitted by the transmission units is only slightly reflected can thereby in particular be improved. A failure safety of the receiving unit can also be increased by using a plurality of light sensors since the total apparatus in accordance with the invention does not become unusable on a failure of individual light sensors. An arrangement of the light sensors in a sensor matrix, wherein preferably the light sensors form pixels of the sensor matrix, represents a particularly preferred and in particular space-saving arrangement of such light sensors. A sensor matrix comprising 600×200 light sensors as pixels has proven to be particularly suitable to achieve as good as possible a coordination between a sensitivity of the receiving unit and the necessary installation space that the receiving unit takes up.

An apparatus in accordance with the invention can be further developed such that the plurality of light sensors comprises a first sensor group and at least a second sensor group that is at least partly different therefrom, and with light sensors of the first sensor group being configured to receive reflected light having the first light property and light sensors of the at least a second sensor group being configured to receive reflected light having the second light property. In other words, specific sensors are preferably present in the receiving unit for each of the light properties to be expected. A recognition and/or differentiation of light having the first light property and the at least a second light property can be particularly easily ensured in this way. The fact can in this respect in particular be utilized that dedicated light sensors for receiving specific light properties can usually be provided smaller, simpler and cheaper than light sensors that are configured to receive light having many different light properties. An apparatus in accordance with the invention can thus be provided in a simpler and less expensive manner overall.

In a preferred further development of an apparatus in accordance with the invention, provision can further be made that the light sensors of the first sensor group and the light sensors of the at least a second sensor group are alternately arranged in the sensor matrix. In other words, it can in this way be ensured that the ability to receive light having the individual different light properties is uniformly or at least substantially uniformly distributed over the total active area of the sensor matrix and thus of the receiving unit. A receiving of light having all the light properties can thus be provided over the total area of the receiving unit that is provided as a sensor matrix.

Furthermore, an apparatus in accordance with the invention can be configured such that the receiving section comprises a first imaging unit, preferably comprising at least one lens, for optically imaging and/or focusing the light reflected from the first illumination section of the monitoring environment and from the at least a second illumination section of the monitoring environment onto the receiving unit. It can be ensured by such a first imaging unit that the light reflected from objects in the monitoring environment also safely arrives at the receiving unit of the receiving section. It can also, for example, be ensured by such a first imaging unit that the incoming reflected light is uniformly distributed to a sensor matrix of the receiving unit. A particularly good illumination of the total receiving unit can thus be ensured.

Alternatively or additionally, provision can be made that the first transmission unit and/or the second transmission unit has/have a second imaging unit, preferably comprising at least one lens, for optically imaging and/or focusing the light transmitted by the corresponding transmission unit into the monitoring environment onto the corresponding first illumination section and/or at least a second illumination section. Analogously to the first imaging unit described above, it can be ensured by such a second imaging unit that light transmitted into the monitoring environment arrives in a focused manner at the corresponding illumination section and preferably illuminates it completely. It can here also, for example, be ensured by such a second imaging unit that the light transmitted by the first and/or second transmission unit is uniformly distributed to the respective illumination section. A particularly good illumination of the total monitoring environment can thus be ensured. Furthermore, these second imaging units can also be used to set and/or change the respective light property, for example, by a polarizing filter and/or a color filter.

Furthermore, provision can be made in an apparatus in accordance with the invention that the first transmission unit and/or the second transmission unit has/have a plurality of light transmitters, with the light transmitters being arranged in a transmitter matrix, in particular as pixels of the transmitter matrix, with the transmitter matrix preferably having 2×4 light transmitters as pixels. Due to a plurality of light transmitters as part of the transmission units, the light power required overall can be distributed to many individual light transmitters. The individual light transmitters can thus in turn be provided as smaller, as consuming less, and overall as less expensive. A failure safety of the respective transmission unit can also be increased by using a plurality of light transmitters since the total apparatus in accordance with the invention does not become unusable on a failure of individual light transmitters. A transmitter matrix that has the individual light transmitters as pixels, particularly preferably a 2×4 transmitter matrix, has proven to be particularly effective in order, on a simultaneous reduction of the size of the individual light transmitters, to nevertheless be able to provide the light power required for the individual transmission units. In an embodiment in which the at least two transmission units are designed in a common assembly, provision can also be made that the light transmitters of both transmission units together form the transmitter matrix, with the respective transmission units then being arranged in an alternating manner in the transmitter matrix.

An apparatus in accordance with the invention can preferably be configured such that the receiving unit is arranged between the first transmission unit and the at least a second transmission unit. In other words, the receiving unit is framed by the transmission units. A particularly space-saving and compact arrangement of the transmission units with respect to the receiving unit, and thereby of the total apparatus in accordance with the invention, can be provided in this way.

In accordance with a second aspect of the invention, the object is satisfied by a vehicle comprising an apparatus for recognizing objects in a monitoring environment. A vehicle in accordance with the invention is characterized in that the apparatus is configured in accordance with the first aspect of the invention. All the advantages that were already described in detail with respect to an apparatus for recognizing objects in a monitoring environment in accordance with the first aspect of the invention can thus also be provided by a vehicle in accordance with the invention in accordance with the second aspect of the invention that has such an apparatus in accordance with the first aspect of the invention.

In an alternative embodiment of the apparatus in accordance with the invention, the apparatus in accordance with the invention can be configured such that the first transmission unit and/or the at least a second transmission unit are configured to scan the respective illumination section. In this respect, this scanning can be provided as an alternative to or in addition to the above-described flash-like illumination of the respective illumination section. On a scanning, the respective illumination section is, for example, scanned line by line by a narrowly focused light beam of the transmission unit, with preferably each of the lines in turn being illuminated in a flash-like manner in the sense of the invention. A spatial and/or local resolution can, for example, be increased on the recognition of objects by a scanning.

In this respect, several advantages result from the presence in accordance with the invention of at least two transmission units that are configured to simultaneously transmit light and from the design of the receiving unit such that it is configured to simultaneously receive reflected light having different light properties.

Due to the presence of at least two transmission units, a scanning speed with respect to the total monitoring environment can thus be increased overall. Since in particular each of the at least two transmission units only scans the illumination section assigned to it and thus only a part of the total monitoring environment, a scan of the total monitoring environment by the at least two transmission units can thus be performed in less time overall than on a use of a single transmission unit. It can thus be achieved that the scanning speed likewise increases, preferably directly proportional increases, as the number of transmission units increases.

At the same time, the illumination section of the monitoring environment illuminated by the individual transmission units can, for example, be reduced for each individual transmission unit such that a scanning speed, i.e. the time required for the illumination of the total illumination section by the respective transmission unit, can thereby also be reduced, on the one hand, and the electrical energy required for this purpose can simultaneously also be reduced.

Alternatively or additionally, the individual transmission units can also scan the respective illumination sections at a higher resolution such that a resolution that can be provided overall can be increased on the recognition of objects in the monitoring environment. Due to the division of the total monitoring environment into illumination sections that are each illuminated by a separate transmission unit, this increase in the resolution can be performed without an increase or at least without a considerable increase of the total time required for an illumination of the monitoring environment.

Further features and advantages of the invention will be described in the following with reference to drawings. Elements having the same function and operation are in each case provided with the same reference numerals in the individual Figures.

There are shown schematically:

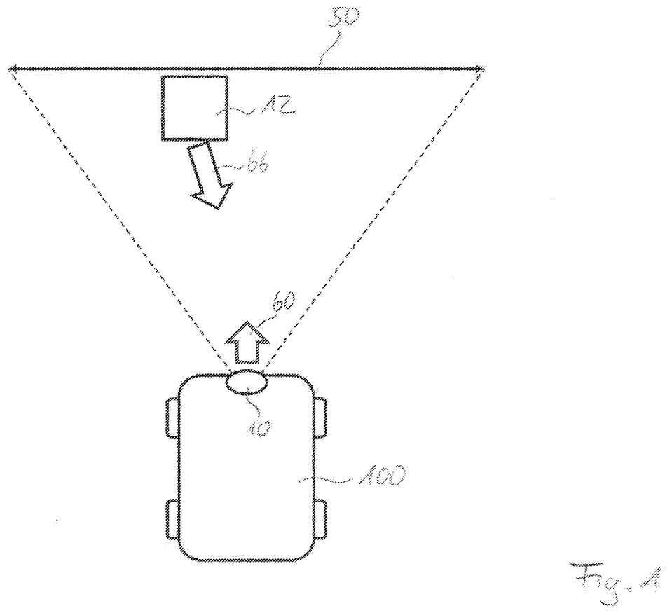

FIG. 1 a vehicle in accordance with the invention;

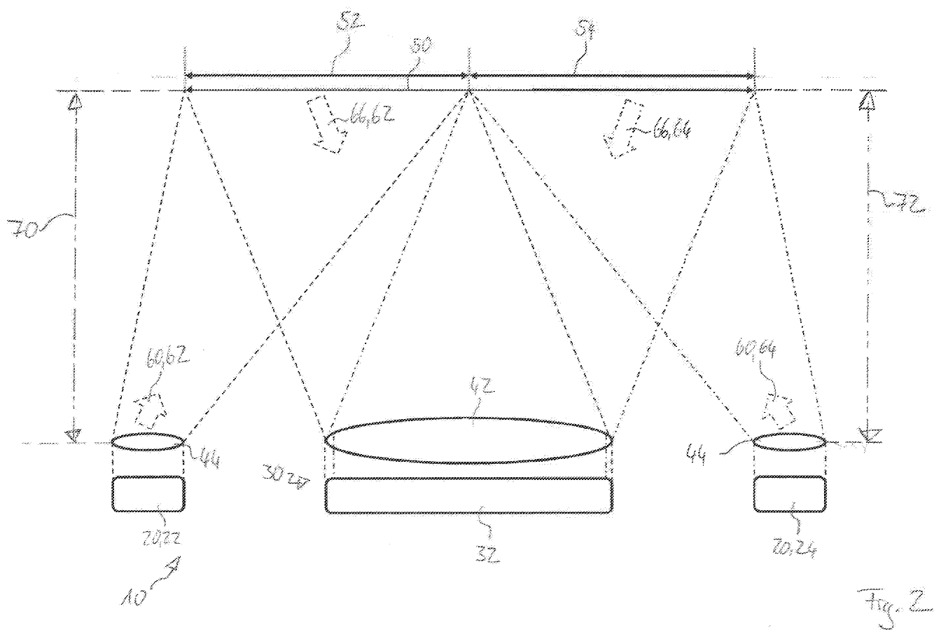

FIG. 2 a first embodiment of an apparatus in accordance with the invention;

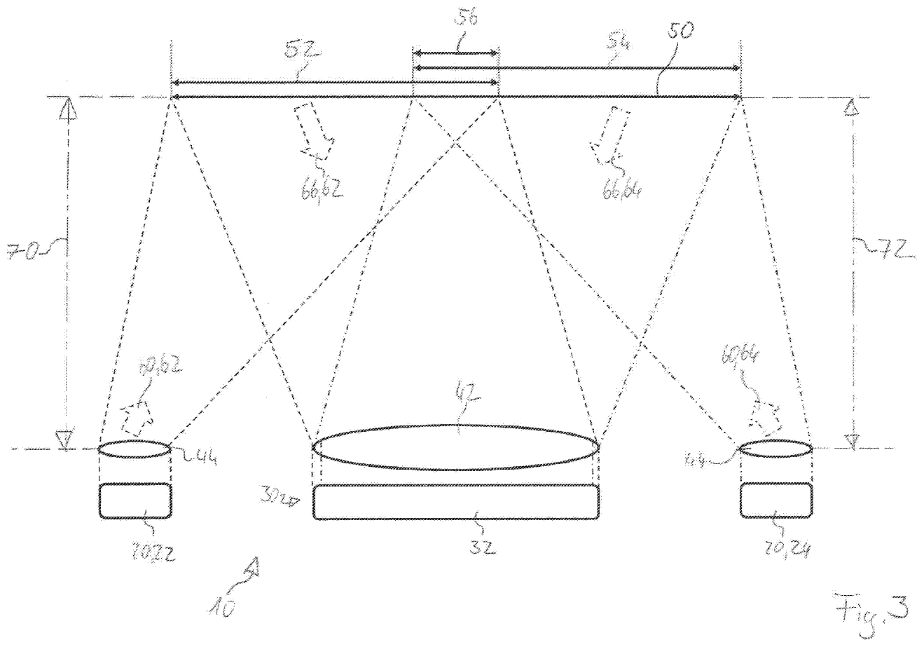

FIG. 3 a second embodiment of an apparatus in accordance with the invention;

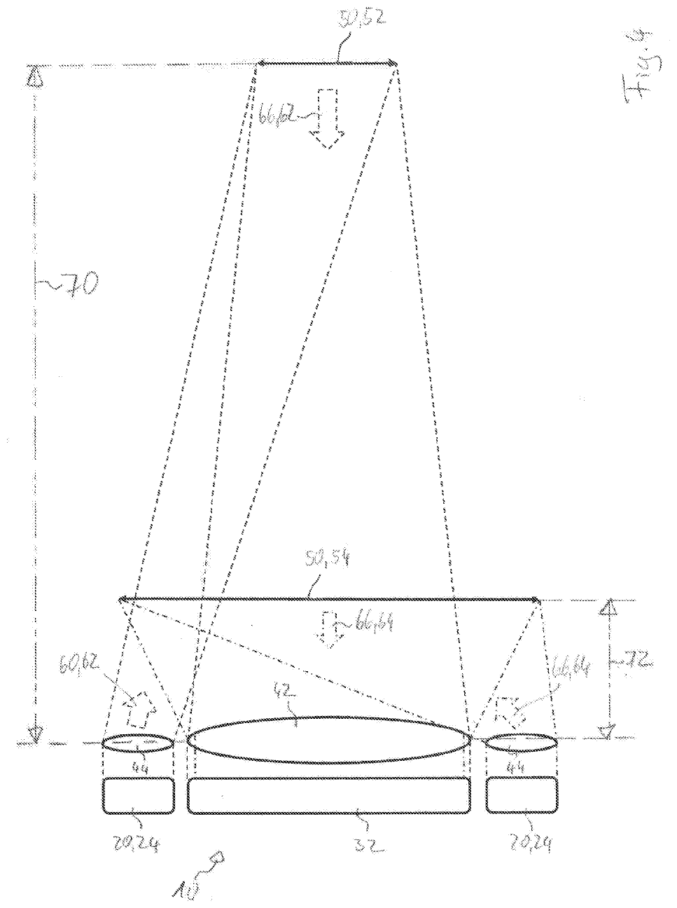

FIG. 4 a third embodiment of an apparatus in accordance with the invention;

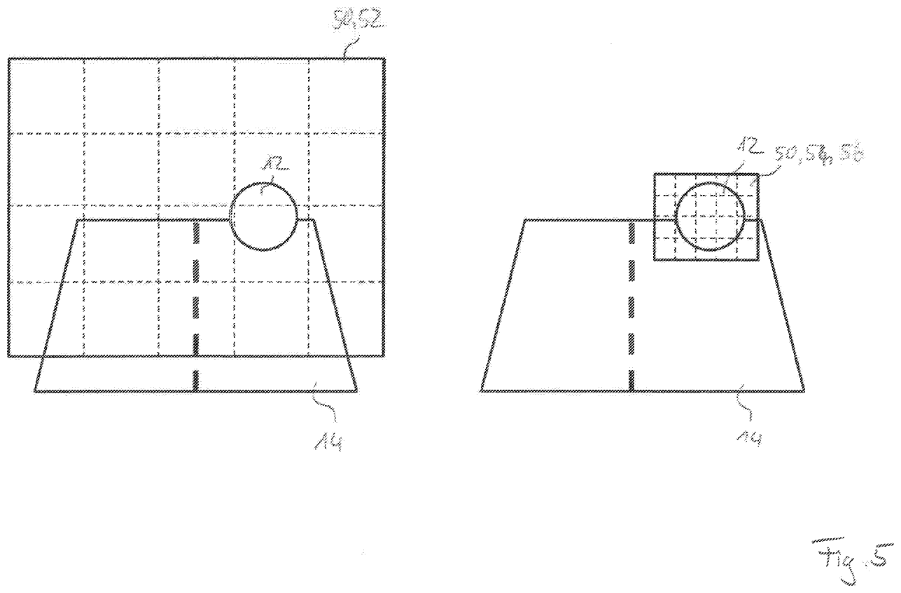

FIG. 5 a possible field of view of an apparatus in accordance with the invention;

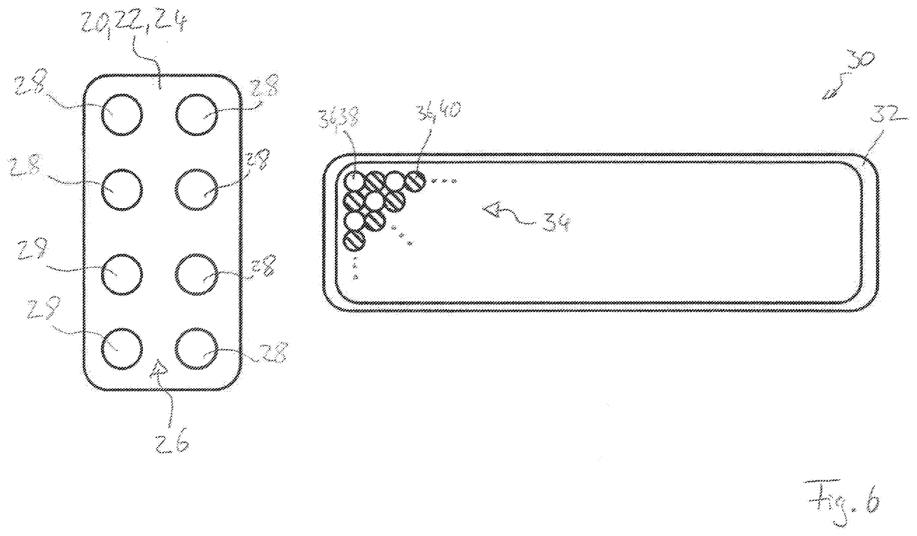

FIG. 6 a transmission unit and a receiving unit;

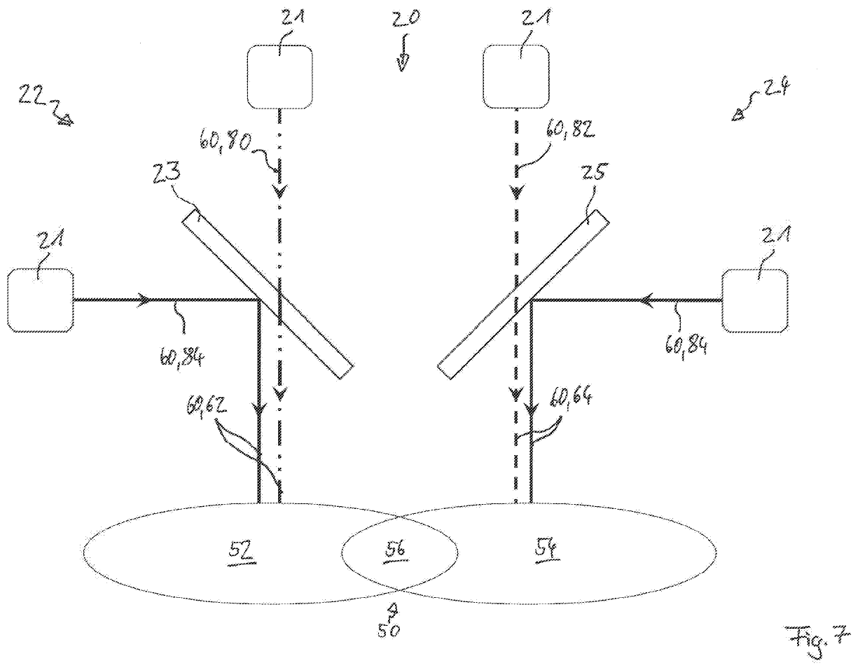

FIG. 7 a further embodiment of a transmission section; and

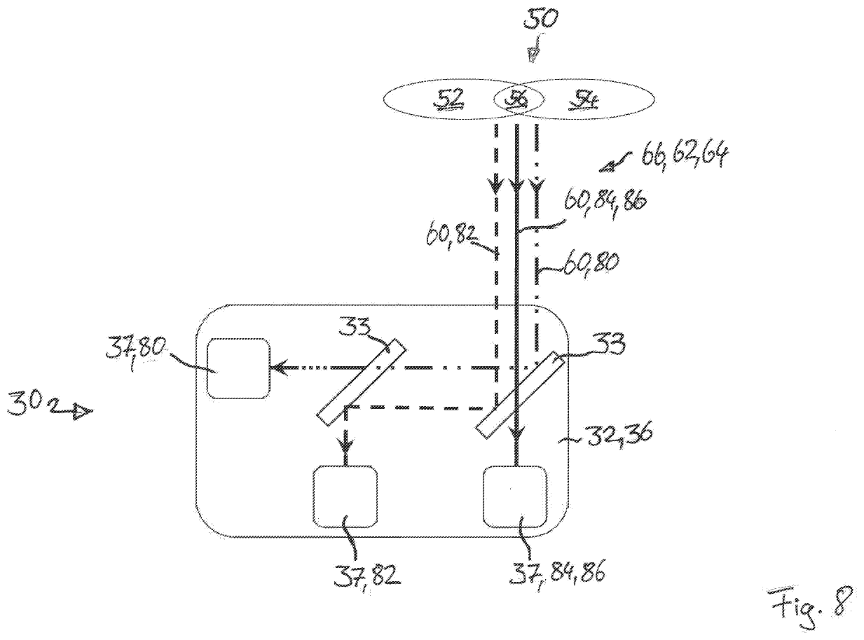

FIG. 8 a further embodiment of a receiving section.

FIG. 1 shows a vehicle 100 that is equipped with an apparatus 10 in accordance with the invention. Light 60 is transmitted into a monitoring environment 50 by the apparatus 10 such as is shown in the further FIGS. 2 and 3, for example. An object 12 that is located in this monitoring environment 50 at least partly reflects the transmitted light 60 as reflected light 66 that is reflected back to the apparatus 10. Due to the apparatus 10, this reflected light 66 is received and subsequently evaluated to recognize the object 12 in the monitoring environment 50. Spacing measurements between the vehicle 100 and the object 12 can thereby, for example, be provided, in particular in order to contribute to a data basis for an autonomous driving of the vehicle 100, for example.

FIG. 2 shows the essential elements of a first embodiment of an apparatus 10 in accordance with the invention. A transmission section 20 and a receiving section 30 are the core of the apparatus 10 in accordance with the invention. As shown, the transmission section 20 can have a first transmission unit 22 and at least a second transmission unit 24 that are configured for the respective transmission of light 60. In this respect, provision is made that the first transmission unit 22 is configured to transmit light 60 having a first light property 62 and the second transmission unit 24 is configured to transmit light 60 having a second light property 64. Light properties 62, 64 can, for example, be a wavelength, a polarization, a phase, and/or a color mixture of the correspondingly transmitted light 60. For example, a color mixture of 40% blue and 20% red can be the first light property 62 and the second light property 64 of the light 60 transmitted by the second transmission unit 24 can be a color mixture of 10% red and 30% green. In the embodiment shown, both transmission units 22, 24 each have a second imaging unit 44. The respective second imaging unit 44, which can, for example, comprise a lens, is configured and provided for optically imaging the transmitted light 60 into or onto the corresponding imaging section 52, 54. A change in the respective light property 62, 64 of the transmitted light 60 can also be provided by such a second imaging unit 44.

The two transmission units 22, 24 transmit their respective light 60 into illumination sections 52, 54 that completely cover the monitoring environment 50 in this embodiment, wherein the first illumination section 52 and the second illumination section 54 do not overlap and directly adjoin one another. A particularly good and energy-saving complete illumination of the total monitoring environment 50 can be provided in this way. Thus, the monitoring environment 50 can, for example, cover a range of 120°×40° in front of the apparatus 10 in accordance with the invention, with the two illumination sections 52, 54 covering this monitoring environment 50 in equal parts and thus preferably, for example, each covering 60°×40°.

The transmission of the respective light 60 by the transmission units 22, 24 can, for example, be performed in the form of a scanning and/or a flash-like illumination of the respective illumination section 52, 54.

Objects 12 (not shown) at which the transmitted light 60 is reflected can be located in the environmental environment 50. This reflected light 66, in each case having the corresponding light property 62, 64, is reflected back to the apparatus 10 in accordance with the invention. In order to receive the reflected light 66, an apparatus 10 in accordance with the invention has a receiving section 30 that, as shown, can preferably be arranged between the two transmission units 22, 24 of the transmission section 20. The reflected light 66 first impacts a first imaging unit 42 of the receiving section 30 that images or focuses the reflected light 66 onto a receiving unit 32 of the receiving section 30 independently of the respective light property 62, 64. In the receiving unit 32, the reflected light 66 is registered with both light properties 62, 64. In an evaluation and analysis performed by the apparatus 10 in accordance with the invention or downstream thereof, it is then possible to draw conclusions from these measurement data on the recognized objects 12 in the monitoring environment 50.

FIG. 3 shows an alternative embodiment of an apparatus 10 in accordance with the invention that essentially only differs from the embodiment shown in FIG. 2 through the division of the monitoring environment 50 into the two illumination sections 52, 54. With respect to the embodiments of the transmission section 20 and the receiving section 30 of the respective apparatus 10 in accordance with the invention, reference is therefore made to the above description of FIG. 2.

In this embodiment of an apparatus 10 in accordance with the invention, provision is made that the first illumination section 52 of the first transmission unit 22 and the second illumination section 54 of the second transmission unit 24 overlap. In other words, a redundancy region 56 is formed in the region of the overlap of the two illumination sections 52, 54 and is illuminated by light 60 having both the first light property 62 and the second light property 64. A particularly high resolution for this redundancy region 56 can be provided in this way.

Furthermore, the two embodiments of an apparatus 10 in accordance with the invention shown in FIG. 2 and FIG. 3 can also be implemented simultaneously when two monitoring environments 50 are viewed at different spacings 70, 72 from the apparatus 10 in accordance with the invention. For example, one or more monitoring environments can in particular also only in an evaluation performed by or downstream of the apparatus in accordance with the invention be defined and/or evaluated at different spacings from the receiving section.

This can in particular and as shown in FIG. 4 also be provided such that the originally provided illumination sections 52, 54 are already set or provided at different spacings 70, 72 from the receiving section 30. A monitoring of a far region, covered by the first illumination section 52 at the first spacing 70, and of a near region, covered by the second illumination section 54 at the second spacing 72, can be simultaneously provided in this way. The total monitoring environment 50 again results from the now spatially separated individual illumination sections 52, 54 and can thus be expanded in a simple manner. As shown, an angular range covered by the first illumination section 52 can in this respect preferably be smaller than an angular range covered by the at least a second illumination section 54. In this way, the energy consumption that is considerably higher on the illumination of the far region can be at least partly compensated.

In FIG. 5, a possible field of view of an apparatus 10 in accordance with the invention of a road 14 with a ball as an object 12 is shown. In this embodiment, the at least a second illumination section 54 is in particular completely overlapped by the first illumination section 52. In other words, the redundancy region 56 is formed by the second illumination section 54. In this way, an object 12 located in this redundancy region 56 can be recognized at a higher resolution and can thereby be recognized in greater detail. The illumination sections 52, 54 in turn together create the monitoring environment 50. Provision can also be made that the illumination sections 52, 54 are provided at different spacings 70, 72 (see FIG. 4) and thus the first illumination section 52 illuminates a far region and the at least a second illumination section 54 illuminates a near region.

FIG. 6 shows possible embodiments of a transmission unit 22, 24 of a transmission section 20 and of a receiving unit 32 of a receiving section 30. Thus, the transmission units 22, 24 can, for example, have light transmitters 28 that are arranged in a transmitter matrix 26. As shown, eight light transmitters 28 can, for example, form a 2×4 transmitter matrix 26. An alternative embodiment in which the at least two transmission units 22, 24 are designed in a common assembly is not shown. In this respect, provision can, for example, be made that light transmitters 28 of both transmission units 22, 24 together form the transmitter matrix 26, wherein the respective transmission units 22, 24 or their light transmitters 28 can then be arranged in an alternating manner in the transmitter matrix 26.

Similar provision can also be made with the receiving unit 32 of the receiving section 30. Thus, a plurality of light sensors 36 can also be provided here that are likewise arranged in the form of a sensor matrix 34, shown schematically here for some light sensors 36. The light sensors 36 can in this respect preferably be combined as a first sensor group 38 and a second sensor group 40, with the individual sensor groups 38, 40 each being configured to recognize one of the two light properties 62, 64 (each not shown). In particular an alternate arrangement of light sensors 36 of the two sensor groups 38, 40 in the sensor matrix 34 has been found to be preferred. The sensor matrix 34 can, for example, preferably have 600×200 light sensors 36 as pixels.

In FIG. 7, a transmission section 20 comprising a first transmission unit 22 and a second transmission unit 24 is schematically shown. The first transmission unit 22 is configured to transmit light 60 having a first light property 62 into a first illumination section 52 of the monitoring environment 50 and the second transmission unit 24 is configured to transmit light 60 having a second light property 64 into a second illumination section 54 of the monitoring environment 50. The two illumination sections 52, 54 overlap in a redundancy region 56 that is illuminated by both transmission units 22, 24.

The two light properties 62, 64 are in particular formed as color mixtures, the first light property 62 is formed as a color mixture of light 60 having a first light color 80 and a third light color 84, the second light property 64 is formed as a color mixture of light 60 having a second light color 82 and likewise the third light color 84. For this purpose, both the first transmission unit 22 and the second transmission unit 24 have the corresponding light emitters 21 that are configured to transmit the light 60 having the respective light color 80, 82, 84.

One dichroic mirror 23, 25 each is provided in each transmission unit 22, 24 for combining the light 60 provided by the light emitters 21. A dichroic mirror 23, 25 is an optical component that selectively reflects only a portion of the light spectrum, in particular light 60 of one wavelength range or light 60 of one light color 80, 82, 84, wherein light 60 outside this wavelength range or light 60 having a different light color 80, 82, 84 can pass through the dichroic mirror 23, 25.

In the embodiment shown of the transmission section 20, both dichroic mirrors 23, 33 are configured to reflect light 60 having the third light color 84. The first dichroic mirror 23 is positioned within the first transmission unit 22 such that light 60 having the first light color 80 passing through it and light 60 having the third light color 84 reflected at it are combined to form light 60 having the first light property 62. Analogously, the second dichroic mirror 25 is positioned within the second transmission unit 24 such that light 60 having the second light color 82 passing through it and light 60 having the third light color 84 reflected at it are combined into light 60 having the second light property 64.

Overall, an internal structure of the transmission units 22, 24 can be simplified by using dichroic mirrors 23, 25 since in particular mechanically moving elements, for example color wheels or the like, for generating or providing the color mixtures as light properties 62, 64 can be dispensed with.

FIG. 8 schematically shows a possible embodiment of a receiving section 30 having a receiving unit 32. A monitoring environment 50 is further shown whose first illumination section 52 is illuminated by the first transmission unit 22 (see FIG. 7) and whose second illumination section 54 is illuminated by the second transmission unit 24 (see FIG. 7). The first illumination section 52 and the second illumination section 54 overlap one another in a redundancy region 56.

Reflected light 66 is reflected back from the monitoring environment 50, wherein this reflected light 66 has both the first light property 62 and the second light property. In the present case, in particular a first light color 80 that originates from the first light property 62, a second light color 82 that originates from the second light property 64, and a third light color 84 and a fourth light color 86 that were or are part of the color mixture of both light properties 62, 64.

The light sensor 36 shown of the receiving unit 32 has three sensor elements 37 that are each particularly sensitive for one or two of these light colors 80, 82, 84 86. Furthermore, two third dichroic mirrors 33 are provided as elements of the receiving unit 36 to split the reflected light 66 into its individual light colors 80, 82, 84, 86. In this respect, the third dichroic mirror 33 that is first in the direction of incidence of the reflected light 66 is permeable for light 66 having the third light color 84 and the fourth light color 86, whereas light 66 having the first light color 80 and the second light color 82 is reflected at it. The continuous light 66 having the third light color 84 and the fourth light color 86 is supplied to the correspondingly sensitive light sensor 37. Accordingly, the third dichroic mirror 33 that is second in the direction of incidence of the reflected light 66 is permeable for light 66 having the first light color 80 and light 66 having the second light color 82 is reflected at it. Correspondingly sensitive sensor elements 37 are positioned relative to this third dichroic mirror 33 to detect the residual reflected light 66 split into the first light color 80 and the second light color 82. Overall, a use of sensor elements 37 that are coordinated with the respective light color 80, 82, 84, 86 and are thus particularly sensitive can increase a sensitivity of the total receiving unit 32 or of the receiving section 30.

### REFERENCE NUMERALS

10 apparatus
12 object
14 road
20 transmission section
21 light emitter
22 first transmission unit
23 first dichroic mirror
24 second transmission unit
25 second dichroic mirror
26 transmitter matrix
28 light transmitter
30 receiving section
32 receiving unit
33 third dichroic mirror
34 sensor matrix
36 light sensor
37 sensor element
38 first sensor group
40 second sensor group
42 first imaging unit
44 second imaging unit
50 monitoring environment
52 first illumination section
54 second illumination section
56 redundancy region
60 light
62 first light property
64 second light property
66 reflected light
70 first spacing
72 second spacing
80 first light color
82 second light color
84 third light color
86 fourth light color
100 vehicle

1. An apparatus for recognizing objects in a monitoring environment, said apparatus having a transmission section for transmitting light into the monitoring environment and a receiving section for receiving light reflected at objects in the monitoring environment,
wherein the transmission section has a first transmission unit for transmitting light having a first light property into a first illumination section of the monitoring environment and at least a second transmission unit for simultaneously transmitting light having a second light property into a second illumination section of the monitoring environment, wherein the first light property and the at least a second light property are formed differently, and wherein the receiving section has a receiving unit for simultaneously receiving reflected light having the first light property and reflected light having the at least a second light property,
wherein
the first light property of the light transmitted by the first transmission unit and the at least a second light property of the light transmitted by the at least a second transmission unit are formed as a color mixture, with a first light color being used only as a portion of the first light property, a second light color being used only as a portion of the second light property, and at least a third light color being used as a portion of both light properties,
with further the first transmission unit and the at least a second transmission unit being configured for a flash-like illumination of the respective illumination section for a complete illumination of the respective illumination section.

2. The apparatus in accordance with claim 1,
wherein blue is used as the first light color, and/or green is used as the second light color, and/or red is used as at least a third light color.

3. The apparatus in accordance with claim 1,
wherein at least a fourth light color is used as a portion of the first light property and/or of the at least a second light property.

4. The apparatus in accordance with claim 1,
wherein a wavelength band around a mean value is used as a light color of a light or wherein the light is formed as monochromatic laser light and the light color of the light is determined by the monochromatic laser light.

5. The apparatus in accordance with claim 1,
wherein the first transmission unit comprises a first dichroic mirror for combining at least light having the first light color and light having the third light color into light having the first light property; and/or
wherein the at least a second transmission unit comprises a second dichroic mirror for combining at least light having the second light color and light having the third light color into light having the second light property.

6. The apparatus in accordance with claim 1,
wherein the receiving section has at least a third dichroic mirror for splitting the light colors of the first light property and the second light property of the reflected light.

7. The apparatus in accordance with claim 1,
that wherein
the first illumination section and the at least a second illumination section completely or at least substantially completely cover the monitoring environment.

8. The apparatus in accordance with claim 7,
wherein the first illumination section and the at least a second illumination section cover the monitoring environment in equal parts or at least substantially equal parts.

9. The apparatus in accordance with claim 1,
wherein the first illumination section and the at least a second illumination section do not overlap; and/or wherein the first illumination section and the at least a second illumination section adjoin one another.

10. The apparatus in accordance with claim 1, wherein
the first illumination section and the at least a second illumination section overlap in a redundancy region.

11. The apparatus in accordance with claim 1,
the first illumination section is arranged at a first spacing from the receiving section and the at least a second illumination section is arranged at a second spacing from the receiving section, with the first spacing and the second spacing being formed differently.

12. The apparatus in accordance with claim 1, wherein
the first transmission unit and/or the at least a second transmission unit and/or the receiving unit are formed free of moving parts.

13. The apparatus (10) in accordance with claim 1,
wherein
the receiving unit has a plurality of light sensors.

14. The apparatus in accordance with claim 13,
wherein the plurality of light sensors comprises a first sensor group and at least a second sensor group that is at least partly different therefrom, and with light sensors of the first sensor group being configured to receive reflected light having the first light property and light sensors of the at least a second sensor group being configured to receive reflected light having the second light property.

15. The apparatus in accordance with claim 14,
wherein the light sensors of the first sensor group and the light sensors of the at least a second sensor group are alternately arranged in the sensor matrix.

16. The apparatus in accordance with claim 1,
wherein the receiving section comprises a first imaging for optically imaging and/or focusing the light reflected from the first illumination section of the monitoring environment and from the at least a second illumination section of the monitoring environment onto the receiving unit; and/or
wherein at least one of the first transmission unit and the second transmission unit has a second imaging unit for optically imaging and/or focusing the light transmitted by the corresponding transmission unit into the monitoring environment onto the corresponding first illumination section and/or at least a second illumination section.

17. The apparatus (10) in accordance with claim 1,
wherein at least one of the first transmission unit and the second transmission unit has a plurality of light transmitters, with the light transmitters being arranged in a transmitter matrix and/or the receiving unit is arranged between the first transmission unit and the at least a second transmission unit.

18. A vehicle comprising an apparatus for recognizing objects in a monitoring environment,
said apparatus having a transmission section for transmitting light into the monitoring environment and a receiving section for receiving light reflected at objects in the monitoring environment,
wherein the transmission section has a first transmission unit for transmitting light having a first light property into a first illumination section of the monitoring environment and at least a second transmission unit for simultaneously transmitting light having a second light property into a second illumination section of the monitoring environment, wherein the first light property and the at least a second light property are formed differently, and wherein the receiving section has a receiving unit for simultaneously receiving reflected light having the first light property and reflected light having the at least a second light property,
wherein the first light property of the light transmitted by the first transmission unit and the at least a second light property of the light transmitted by the at least a second transmission unit are formed as a color mixture, with a first light color being used only as a portion of the first light property, a second light color being used only as a portion of the second light property, and at least a third light color being used as a portion of both light properties,
with further the first transmission unit and the at least a second transmission unit being configured for a flash-like illumination of the respective illumination section for a complete illumination of the respective illumination section.
